(19) United States
(12) Patent Application Publication
(10) Pub. No.: US 2002/0023797 A1
(43) Pub. Date: Feb. 28, 2002

(54) Manually triggered vehicle restraint release system

(76) Inventor: Albert Baca, Placitas, NM (US)

Correspondence Address: PEACOCK MYERS AND ADAMS P C, P O BOX 26927, ALBUQUERQUE, NM, 871256927

(21) Appl. No.: 09/939,165

(22) Filed: Aug. 24, 2001

Related U.S. Application Data
(60) Provisional application No. 60/228,319, filed on Aug. 25, 2000.

(51) Int. Cl. B60R 21/00

(52) U.S. Cl. 180/271; 180/268; 307/10.1

(57) ABSTRACT

A vehicle restraint release system and method comprising: providing a manual trigger; providing a vehicle motion sensor; providing a safety interlock connected to the manual trigger and the vehicle motion sensor; and causing activation of a plurality of restraint release devices when the manual trigger is engaged and the vehicle motion sensor signals that the vehicle is not in motion.

### CROSS-REFERENCE TO RELATED APPLICATIONS

This application claims the benefit of the filing of U.S. Provisional Patent Application Ser. No. 60/228,319, entitled “Manually Triggered Vehicle Restraint Release System”, filed on Aug. 25, 2000, and the specification thereof is incorporated herein by reference.

### BACKGROUND OF THE INVENTION

1. Field of the Invention (Technical Field)

The present invention relates to vehicle safety devices, particularly for release of occupant restraints.

2. Background Art

Although present day automotive vehicles are provided with well-developed occupant restraints or seat belts, there are situations in which drivers, passengers, or rescue workers need to free helpless vehicle occupants rapidly, such as in the aftermath of an accident. The manually triggered release system of the invention for vehicle occupant restraints addresses such situations.

### SUMMARY OF THE INVENTION (DISCLOSURE OF THE INVENTION)

The present invention is of a vehicle restraint release system and method comprising: providing a manual trigger; providing a vehicle motion sensor; providing a safety interlock connected to the manual trigger and the vehicle motion sensor; and causing activation of a plurality of restraint release devices when the manual trigger is engaged and the vehicle motion sensor signals that the vehicle is not in motion. In the preferred embodiment, one or more restraint condition sensors are connected to the safety interlock. The restraint release devices comprise automatic means for releasing safety belt buckles, automatic means for releasing safety belt anchor points, solenoid means, automatic means for rolling down windows, automatic means for unlocking windows, automatic means for unlocking doors, automatic means for releasing a safety harness from all anchor points, automatic means for releasing an airbag from its anchor point, and/or automatic means for returning a steering wheel to a maximally open position, in any desired combination.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a block diagram of the manually triggered vehicle restraint release system of the invention; and

FIG. 2 illustrates restraint release devices located at various appropriate points.

### DESCRIPTION OF THE PREFERRED EMBODIMENTS (BEST MODES FOR CARRYING OUT THE INVENTION)

The manually triggered vehicle restraint release system of the invention enhances vehicular safety by providing a rapid means of manually releasing all vehicle occupant restraints in the aftermath of an accident. Use of the system of the invention would, for example, allow parents to quickly remove small children from a vehicle in an emergency situation. Similarly, rescue workers would have the ability to rapidly remove incapacitated persons to prevent further injury or loss of life.

For purposes of the specification and claims, “restraint release device” is defined to include systems operating to release systems which operate to (although not necessarily designed to) keep occupants in a vehicle, including safety belts and harnesses, door locks, window locks, windows, and airbag systems (which can become entangled with drivers and/or passengers when deployed).

Most problematic in crash situations are safety belts and harnesses. The manually triggered vehicle restraint release system of the invention when employed with safety belts and/or harnesses preferably comprises:

1. A series of restraint release devices located at all restraint anchor points. These devices can release restraints at their anchor points via electrical, mechanical, electromechanical, chemical, or other means. It is preferred to use electromechanical solenoids to release buckle mechanisms. These buckle mechanisms could otherwise be similar to those currently used with automotive seatbelts.

2. A means of actuating all restrain release devices simultaneously. The system of the invention preferably uses a central control mechanism for all release devices.

3. A protected manual trigger in one or more locations that provides easy access for the driver or rescue workers and optionally passengers. This feature can take the form of a protected mechanical switch or other means that prevents unintentional actuation of the release.

4. Sensor(s) indicating the state (engaged or disengaged) of the restraint anchors.

5. Sensor(s) indicating whether or not the vehicle is in motion.

6. A safety interlock that prevents the release system from being actuated while the vehicle is in motion, and that prevents the vehicle from starting if the release system has been actuated and the restraints are not engaged.

When the vehicle is started, the safety interlock portion of the system of the invention checks sensor inputs for all of the restraint anchors in the vehicle. If all anchors are engaged, the safety interlock will allow the vehicle to start normally. Otherwise, if one or more of the restraint anchors are disengaged, the safety interlock will disable the ignition system, and prevent a vehicle start until all restraint anchors are re-engaged.

Once the vehicle is in motion, the safety interlock will monitor a motion indicating input, and will prevent an accidental release of the restraints.

In the event of an accident, the system of the invention preferably releases all vehicle occupant restraints when a manual switch is actuated. This rapid release would allow parents to quickly remove a child in a child safety seat. Rescue workers would also be able to quickly remove incapacitated persons from the vehicle, preventing further injury or loss of life.

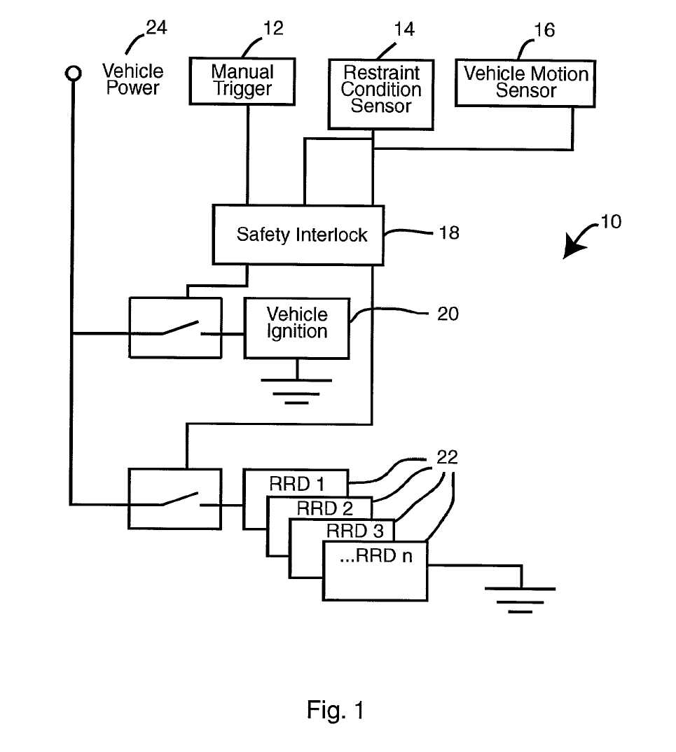

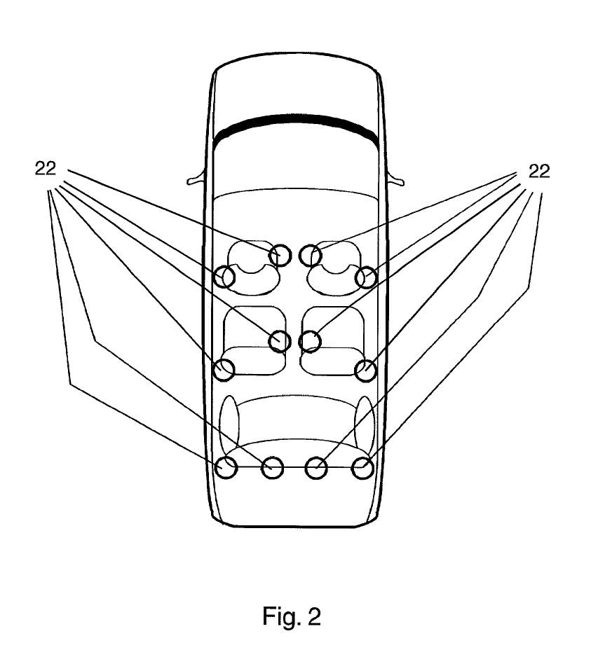

FIG. 1 illustrates the preferred restraint release system 10 of the invention, comprising manual trigger 12, restraint condition sensor 14, vehicle motion sensor 16, safety interlock 18, vehicle ignition 20, and plurality of restraint release devices (RRDs) 22. FIG. 2 shows restraint release devices 22 located at various points, such as at all restraint anchor points for safety belts.

The present invention can be adapted for restraints of any kind in a vehicle by utilizing an isolated circuit, for example: windows, air bags, steering wheels, door locks, etc. The system will also adapt for use with military or private vehicles that employ occupant restraints (such as vehicles used in auto racing), as well as aircraft, commercial airlines or other vehicles that employ occupant restraints.

A restraint release device accessory adapter is preferably provided for a child's seat and/or a child restraint integrated with the system of the invention. Child seat manufacturers can add the system of the invention to their product, which will activate their product once connected to the system of the invention.

The system of the invention provides a significant safety enhancement to current vehicles. Enabling one person to free others from a vehicle in an emergency situation will save lives. In addition, the system has advantages over automatic release mechanisms in that someone must make a conscious effort to release vehicle occupants from their restraints, thereby preventing potentially dangerous automated releases.

Many crash victims would be here today if their cars had been equipped with a system of the invention. The moments of any serious transportation accident are filled with shock, panic and confusion. When getting free from the vehicle quickly is a matter of life and death-as is the case in a significant and growing number of accidents-intense fear makes the otherwise routine procedure of releasing safety restraints impractical or impossible.

Consider the following situations that lead to death or additional injury:

Vehicle occupants are too injured to operate restraint release systems.

Damage to the vehicle prevents access to a restraint release.

A crash victim lies unconscious in a vehicle and is an impediment to his or her own extraction from the vehicle by anyone attempting a rescue.

Debris within the vehicle prevents easy or practical access to restraint release systems.

A vehicle has landed on its side or roof creating any number of additional complications, most notably gravitational pressure against the restraint device.

A vehicle becomes submerged in water so that the restraint release is not visible.

Releasing a child from a car seat, which can be difficult even in normal circumstances, becomes extremely problematic.

Several people are unconscious, injured and/or trapped as rescue personnel race against time to extract them from heavily damaged vehicle in a dangerous situation.

Shock, fear, confusion and panic are always complicating factors in a serious accident. The additional pressure of having to escape water, fire, suffocation or other life threatening situations increase the likelihood of death and/or serious injury that would otherwise not happen.

In the film “An Officer and a Gentleman” flight school candidates take their turn riding in the “Delbert Dunker.” The dunker is a contraption that simulates the crash of an airplane into water. As the cockpit becomes submerged, disoriented officer candidates must free themselves from their restraints. The otherwise routine procedure becomes much more difficult and one candidate nearly drowns and has to be resuscitated via CPR. This film provides a graphic illustration of the real-life drama that happens when Restraint Rapid Release becomes critical. Young, physically fit, trained military personnel can practice restraint release in a controlled environment. The rest of us are not so fortunate.

Accordingly, many lives could be saved every year by the present invention. In the event of a serious accident, any vehicle occupant or would-be-rescuer could quickly and instantly free all people within the vehicle from their restraints by pushing a red button on the inside roof of the vehicle. The manually triggered electronic device will: 1) release all seatbelts at both anchor positions; 2) unlock and lower all or some of the vehicle windows; 3) unlock all doors; and 4) release from their anchor points any airbags inflated on impact. The system of the present invention preferably has a back-up power source in the event of power loss in the vehicle.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A vehicle restraint release system comprising:
a manual trigger;
a vehicle motion sensor;
a safety interlock connected to said manual trigger and said vehicle motion sensor; and
a plurality of restraint release devices that activate when said manual trigger is engaged and said vehicle motion sensor signals that the vehicle is not in motion.

2. The system of claim 1 additionally comprising one or more restraint condition sensors connected to said safety interlock.

3. The system of claim 1 wherein said restraint release devices comprise automatic means for releasing safety belt buckles.

4. The system of claim 1 wherein said restraint release devices comprise automatic means for releasing safety belt anchor points.

5. The system of claim 1 wherein said restraint release devices comprise solenoid means.

6. The system of claim 1 wherein said restraint release devices comprise automatic means for rolling down windows.

7. The system of claim 1 wherein said restraint release devices comprise automatic means for unlocking window s.

8. The system of claim 1 wherein said restraint release devices comprise automatic means for unlocking doors.

9. The system of claim 1 wherein said restraint release devices comprise automatic means for releasing a safety harness from all anchor points.

10. The system of claim 1 wherein said restraint release devices comprise automatic means for releasing an airbag from its anchor point.

11. The system of claim 1 wherein said restraint release devices comprise automatic means for returning a steering wheel to a maximally open position.

12. A vehicle restraint release method comprising the steps of:
providing a manual trigger;
providing a vehicle motion sensor;
providing a safety interlock connected to the manual trigger and the vehicle motion sensor; and
causing activation of a plurality of restraint release devices when the manual trigger is engaged and the vehicle motion sensor signals that the vehicle is not in motion.

13. The method of claim 1 additionally comprising the step of providing one or more restraint condition sensors connected to the safety interlock.

14. The method of claim 1 wherein in the causing step the restraint release devices comprise automatic means for releasing safety belt buckles.

15. The method of claim 1 wherein in the causing step the restraint release devices comprise automatic means for releasing safety belt anchor points.

16. The method of claim 1 wherein in the causing step the restraint release devices comprise solenoid means.

17. The method of claim 1 wherein in the causing step the restraint release devices comprise automatic means for rolling down windows.

18. The method of claim 1 wherein in the causing step the restraint release devices comprise automatic means for unlocking windows.

19. The method of claim 1 wherein in the causing step the restraint release devices comprise automatic means for unlocking doors.

20. The method of claim 1 wherein in the causing step the restraint release devices comprise automatic means for releasing a safety harness from all anchor points.

21. The method of claim 1 wherein in the causing step the restraint release devices comprise automatic means for releasing an airbag from its anchor point.

22. The method of claim 1 wherein in the causing step the restraint release devices comprise automatic means for returning a steering wheel to a maximally open position.
